(19) United States
(12) Patent Application Publication
(10) Pub. No.: US 2010/0298051 A1
(43) Pub. Date: Nov. 25, 2010

(54) WAGERING GAME TABLE AUDIO SYSTEM

(75) Inventors: Timothy C. Loose, Chicago, IL (US); Eric M. Pryzby, Skokie, IL (US); Paul Radek, Naperville, IL (US); Alfred Thomas, Las Vegas, NV (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/739,360

(22) PCT Filed: Oct. 20, 2008
(86) PCT No.: PCT/US08/11943

§ 371 Date: Aug. 12, 2010

Related U.S. Application Data
(60) Provisional application No. 60/981,660, filed on Oct. 22, 2007.
(60) Provisional application No. 60/986,712, filed on Nov. 9, 2007.

(51) Int. Cl. A63F 13/00

(52) U.S. Cl. 463/35

(57) ABSTRACT

A computerized wagering game table system includes a wagering game module that is operable to present a wagering game upon which monetary value can be wagered, and an audio system. The audio system is operable to present different sound to each of a plurality of game players seated at the wagering game table.

### RELATED APPLICATIONS

This patent application claims the priority benefit of U.S. Provisional Patent Application Ser. No. 60/981,660 filed Oct. 22, 2007 and entitled “WAGERING GAME TABLE AUDIO SYSTEM”, and of U.S. Provisional Patent Application Ser. No. 60/986,712 filed Nov. 9, 2007 and entitled “WAGERING GAME TABLE AUDIO SYSTEM”, the contents of which are incorporated herein by reference in their entirety.

### FIELD OF THE INVENTION

The invention relates generally to wagering game audio, and more specifically to audio systems for wagering game tables.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games often do not rely on the dealer or other game players to facilitate game play and to provide an entertaining game playing environment, but rely upon the presentation of the game and environment generated by the wagering game machine itself. Incorporation of audio, video, and mechanical features into wagering game systems enhance the environment presented are therefore important elements in the attractiveness and commercial success of a computerized wagering game system. Further, a variety of network configurations and capabilities are becoming increasingly common, including local and wide area progressive games, downloadable games, and remotely managed wagering game systems.

Although traditional wagering game machines took the form of upright slot machines or other similar games and configurations, the popularity of table games such as blackjack and poker has led to computerization of table-based wagering games as well. The challenges in interacting with players spread out around a common game table make design of electronic wagering game tables, and incorporation of interface elements into the game table environment, a significant challenge.

### SUMMARY

Various example embodiments of the invention comprise a computerized wagering game table system, including a wagering game module that is operable to present a wagering game upon which monetary value can be wagered, and an audio system. The audio system is operable to present different sound to each of a plurality of game players seated at the wagering game table.

### BRIEF DESCRIPTION OF THE FIGURES

FIG. 1 shows a typical computerized wagering game machine, as may be used to practice some example embodiments of the invention.

FIG. 2A-2D are block diagrams of a wagering game system, consistent with some example embodiments of the invention.

FIG. 3 shows a table-based wagering game system, as may be used to practice various embodiments of the invention.

FIG. 4 illustrates an example wagering game chair, consistent with an example embodiment of the invention.

FIG. 5 is a Bluetooth headset, as may be used to practice an embodiment of the invention.

FIGS. 6A-6D show table-based wagering game systems, as may be used to practice various embodiments of the invention.

FIG. 7 is a perspective view of a wagering game table system, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Some example embodiments of the invention comprise Some example embodiments of the invention comprise a comprise a computerized wagering game table system, including a wagering game module that is operable to present a wagering game upon which monetary value can be wagered, and an audio system. The audio system is operable to selectively direct sound to one of one or more wagering game players playing a wagering game at the wagering game table, or to present different sound to each of a plurality of game players seated at the wagering game table.

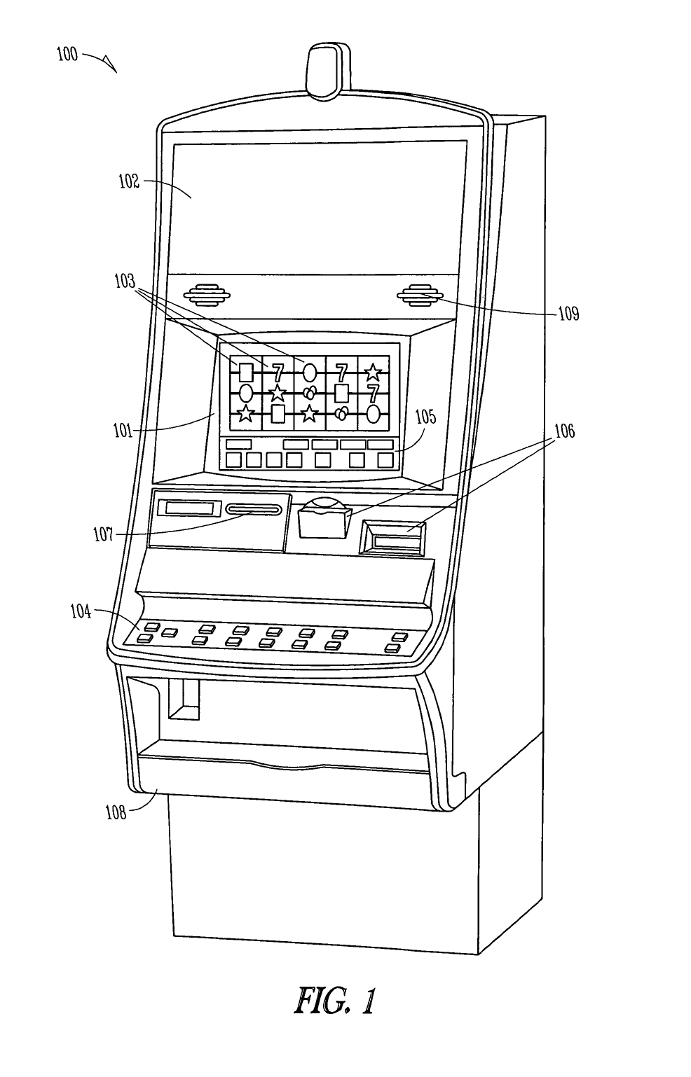

FIG. 1 illustrates a typical single player computerized wagering game machine, as may be used in some embodiments of the present invention. The computerized gaming system shown generally at 100 is a video wagering game system, which displays information for at least one wagering game upon which monetary value can be wagered on video display 101. In a further example, a second video display 102 is provided as a part of a top-box assembly, such as to display a bonus game or other information. Video displays 101 and 102 are in various embodiments a CRT display, a plasma display, an LCD display, a surface conducting electron emitter display, or any other type of display suitable for displaying electronically provided display information. Alternate embodiments of the invention will have other game indicators, such as mechanical reels instead of the video graphics reels shown at 103 that comprise a part of a video slot machine wagering game.

A wagering game is presented using software within the wagering game machine, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, including such well-known wagering games as reel slots, video poker, blackjack, craps, roulette, or hold 'em games. The wagering game is played and controlled with inputs such as various buttons 104 or via touchscreen overlay buttons 105 on video screen 101. In some alternate examples, other devices such as pull arm are used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 106 or a secure user identification module interface 107, and winnings are returned via the returned value card or through the coin tray 108. Sound is also provided through speakers 109, typically including audio indicators of game play, such as reel spins, credit bang-ups, and environmental or other sound effects or music to provide entertainment consistent with a theme of the computerized wagering game.

In some further embodiments, the wagering game machine is coupled to a network, and is operable to use its network connection to receive wagering game data, track players and monetary value associated with a player, and to perform other such functions. In other embodiments, the wagering game system is a portable wagering game system, or has another format different from that illustrated in FIG. 1. In one such example, the wagering game system is a game table, having one or more display surfaces and one or more speakers to interact with multiple wagering game players positioned around the table.

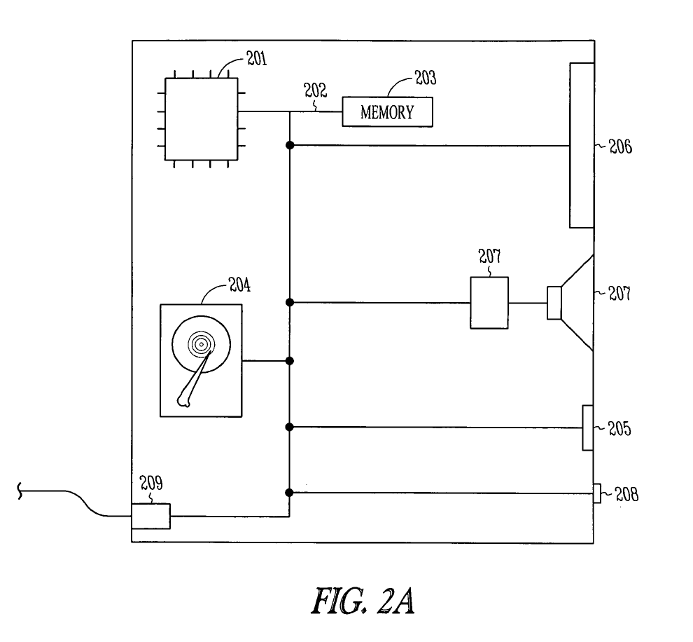

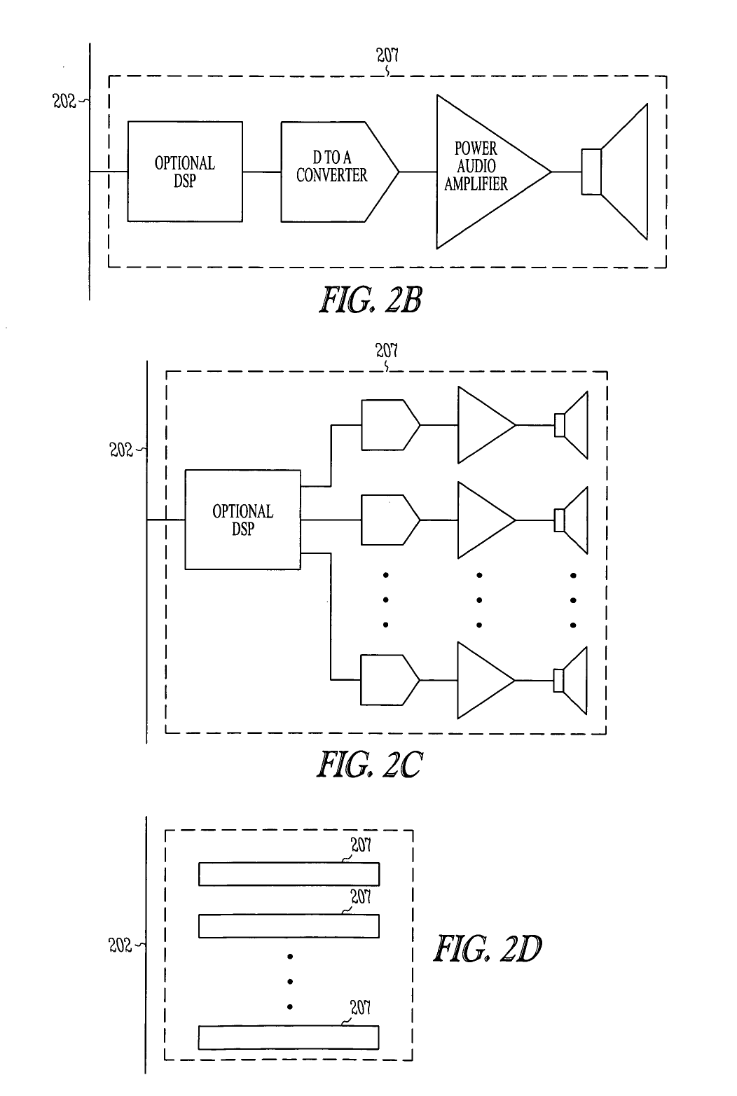

FIG. 2A shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HD-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and audio module 207 serve to provide an interface between the wagering game system and a wagering game player, as do various other components such as buttons 208, pullarms, and joysticks. A network interface 209 provides communication to external wagering game machines and to a wagering game server, such as to provide downloadable games or to provide accounting, player tracking, or other functions. These components are located in a wagering game machine cabinet such as that of FIG. 1 in some embodiments, but can be located in multiple enclosures comprising a wagering game system or outside a wagering game machine cabinet in other embodiments, or in alternate forms such as a wireless or mobile device.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof. The wagering game machine is coupled to other wagering game machines, and to various other elements such as game servers, accounting servers, or community or progressive game servers via the network connection 209, and exchanges data with these machines via the network connection. The audio module serves as the interface between the processor 201 and the player for audible output. The sound module includes a digital interface to the bus 202, and all the means necessary to convert the digital sound information to sounds audible to the player, or players.

One implementation of the sound module is shown in FIG. 2B. The bus 202 connects to an option digital signal processor (DSP). The DSP can provide additional signal processing and enhancement functions, such as file decompression, frequency range enhancement, dynamic range enhancement, psychoacoustic processing, and other functions. The digital signals from this module are converted to analog signals by a digital to analog (D/A) converter, then amplified by the audio power amp. The audio power amp provides a signal suitable for directly driving the speaker.

When more than one channel of audio is to be presented to the player(s), and multi-channel audio system is required. FIG. 2C and FIG. 2D describe two further embodiments of a multichannel audio system.

FIG. 2C has one DSP (or other interface to the bus 202), with multiple digital output channels. Each digital output channel drives its own D/A converter, audio power amp, and speaker. This system shares one DSP among all the audio channels, and is the most cost effective approach if the DSP has sufficient signal processing capabilities for the application.

In FIG. 2D, each audio channel has its own sound module 207, as in FIG. 2B. This approach provides the maximum signal processing power and flexibility, but also has the highest cost.

Table-based wagering games, such as blackjack, poker, or other common table games, can also be automated as computer-based games. Computerized table games have the advantage that it is more difficult to interfere with cards or chips during play, either unintentionally or intentionally to cheat the wagering game establishment. Computerized table games also provide a sense of security to the game players, who can feel more secure in the integrity and accuracy of the game and their winnings.

Computerized wagering game tables can also provide the same level of instruction and supervision as a dealer, prompting game players when a decision needs to be made or when to bet, and informing the game players of the results. For example, a computerized wagering table game might include a computerized voice that provides instruction when a player does not act within a certain period of time, and may provide instruction as to how to play a game. Computerized wagering game tables have an advantage over traditional game tables in that they can further provide music, sound effects, video, graphics, and other multimedia features, enhancing game play. In one example, a computerized table game has a theme, such as a fishing theme, a wild west theme, or a popular movie theme, that is presented through graphics, video, sound effects, music, and voices.

Some sounds are related to a wagering game element, and are desirably tied to or associated with the wagering game element such as by having the associated sounds appear to come from the location of the game element, or follow or track movement of the wagering game element on the wagering game table. Sounds such as individual player credit bang-up, instructions, and other such sounds are in some examples intended for a single game player, and need not be played for all game participants at a table game. In some such examples, the sound that is presented to each of two or more game players is different, such as by use of individual speakers local to each game player or by use of other audio technologies. Altering the phase or amplitude of sounds played through two or more speakers can be used to direct sound, such as is done with amplitude-steered arrays or phase-steered arrays line sonar or ultrasound. Similarly, use of speaker elements or assemblies that are directional, such as speakers with reflectors or dipole or other speakers having a tailored sound radiation pattern can be used to direct sound at some game players to a greater degree than others.

Psychoacoustic processing of sound can cause the sounds to appear as though they come from different directions or have other different characteristics, and can be used to enhance presentation of sound to specific game players. Sound can be provided more directly to some game players than others through use of individual speakers for each player, such as through use of chairs that incorporate speakers, or by using other technologies such as Bluetooth transmitters that provide separate sounds to various players wearing Bluetooth headsets or earphones.

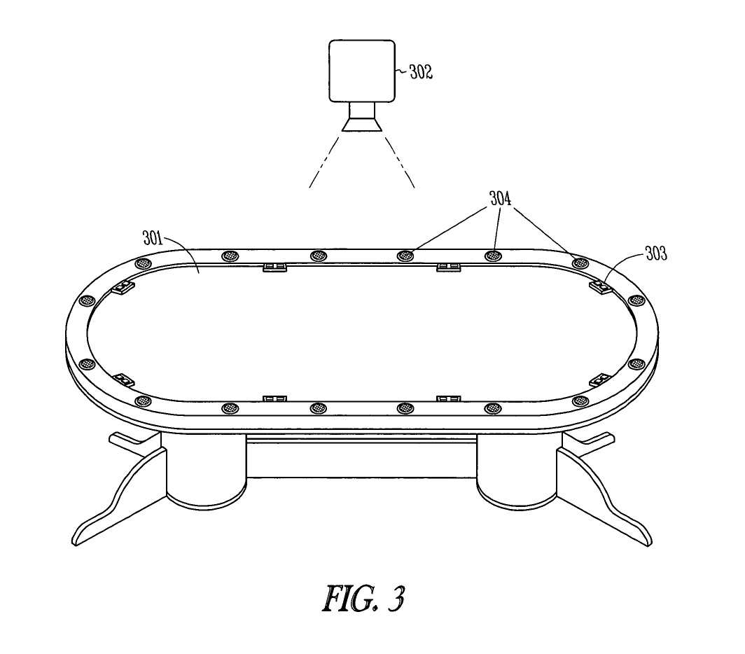

One example of a computerized wagering game table system is shown in FIG. 3, which may be used to practice some embodiments of the invention. In this example, a table 301 comprises a game playing surface, and a number of stations or places at which game players can sit around the table to access the playing surface and play a wagering game. This example includes a table surface that incorporates a display, such as a plasma or LCD display, or an overhead projector 302 that is operable to project an image onto the playing surface.

In a further example, the playing surface is receptive to touch, such as by using a transparent touchscreen overlay, ultrasonic or optical detectors, or other such sensors on or near the table surface. Other inputs are also provided in various embodiments, including buttons 303 located at each station. Each game play station in this embodiment also includes a pair of speakers 304, which in this example are built into a rail or edge of the game table but in other embodiments are positioned elsewhere, such as on another part of the table, on a chair, in a central location but directed toward individual game players, or elsewhere in the game environment.

The speakers 304 associated with a particular game play station are in some embodiments operable to play sounds directed toward only the game player seated at that station, such as to provide instruction, credit bang-up, or other information relevant or intended only for that specific game player. In a further example, the game players all act at the same time, such as while competing in a bonus game, and the sounds presented to each game player are relevant to the particular game player's progress in the bonus game. In other examples, multimedia presentation is tailored to each player, or varies depending on a player's recent luck, player tracking status, or on other criteria, and is presented differently to different game players.

The audio is presented to a specific game player through proximity of the local speakers at each station to a specific game player, but in other examples comprises other technologies to provide local or directional sound. In one such example, the sound played through the speakers 304 is manipulated in phase, such that phase cancellation causes sounds intended for a particular game player to be less audible to adjacent game players. Similarly, amplitude adjustment between speakers can be used to reduce audibility of sounds to neighboring game players, resulting in enhanced localization of sound played through speakers 304.

In addition to using phase and amplitude technologies such as those used in phase-steered arrays and amplitude-steered arrays, various psychoacoustic processing can be used to further enhance the perceived loudness, direction, and other characteristics of sound. In one such embodiment, psychoacoustic processing is used to cause sound localization of selected audio to the vicinity of an associated wagering game element, or to the selected game players. Altering the amplitude, phase, and time difference between sounds arriving at the ears of game players positioned in specific game player locations can be performed in conjunction with a psychoacoustic model to process audio before it is played through speakers 304 to make it sound as though it's coming from a location other than from the speakers, resulting in sound that appears directed toward or most local to a specific game player.

In a more specific application of psychoacoustic processing, the position of a game object, such as an object displayed or projected onto the game table 301, is used to apply psychoacoustic processing to associated sounds to enhance presentation of the object. For example, a displayed pile of chips may be associated with a chip “splash” sound that is tied to the location in which a displayed chip impacts a chip pile, the sound of a displayed card sliding across the table may move with a card as it slides from a dealer location to a specific game player, or rolling dice may make a sound as the displayed dice travel across the wagering game table, impact a side wall, and come to rest in various positions across the table's display area. In further examples, multimedia elements such as animated characters that make noises or have voices move around the playing table surface in conjunction with movement of the multimedia element, such as may be used to provide instruction or entertain the wagering game players.

Psychoacoustic processing is applied in one example by applying psychoacoustic algorithms, such as by filtering audio using an audio processor comprising a part of an audio adapter in a computerized wagering game control computer. In some embodiments the same audio adapter is used to generate audio for each game player's station, while in other embodiments multiple audio adapters are used to distribute the workload of applying sound processing to speakers for multiple game players.

The speaker configuration varies in some embodiments, such as by using speakers that are designed to be directional or that have other acoustic properties that enhance the speaker system's ability to provide sound that appears to be directional or local to a specific wagering game player. In one such example, a speaker is positioned behind a baffle that shields direct acoustic radiation from all but the intended wagering game player. In another example, an acoustic reflector is used to direct sound from a particular speaker toward a particular game player, increasing the sound level perceived by the intended game player while reducing sound radiation in other directions. Dipole speakers, or speakers mounted on relatively small baffles that project sound in both a forward and reverse direction, have a radiation patter that is significantly weaker to the side of the speaker than perpendicular to the plane of the speaker. If the game player is located perpendicular to the plane of the speaker such that the speaker is directed toward him, the resulting sound is significantly more audible to the game player than to people to either side.

Ultrasonic technology is used in another embodiment, such that an array of ultrasonic transducers emits ultrasonic sounds that interfere with one another to produce audible sound at one or more intended locations. In one such example, ultrasonic transducers positioned around the game table 301 are used to produce sounds that are audible only in the desired locations, such as in specific game player locations, and are otherwise inaudible or very quiet. In another embodiment, the ultrasonic array is positioned above the game table, and can be used to generate sound in specific locations, such as in the vicinity of specific game players or on the table in association with a displayed game object. In such an embodiment, sound may be reflected off a surface such as the game table to make it sound as though the object is generating the sound.

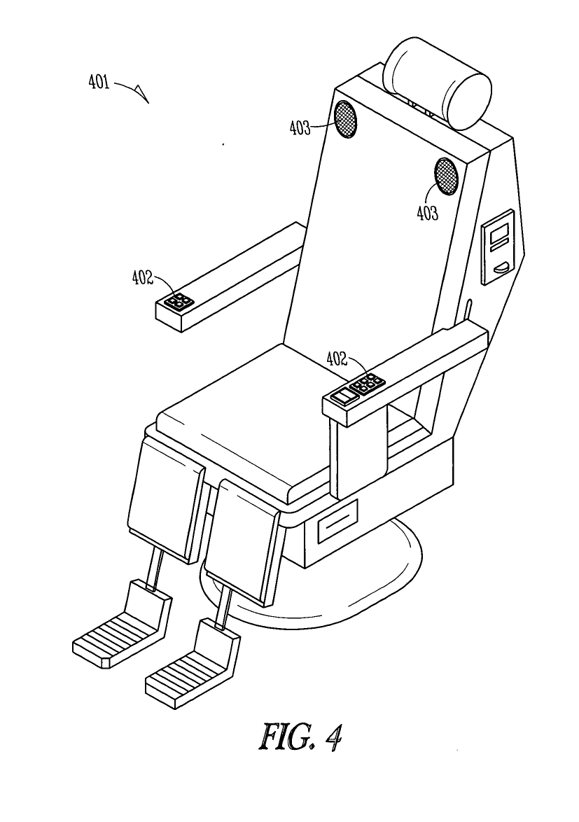

FIG. 4 shows another application of directed audio for use in a wagering game table, using speakers embedded in a game player's chair. In this example, the chair 401 comprises a variety of features, including player interface to the wagering game via buttons 402, and speakers 403 located very near the game player's head. Sound played via such a wagering game chair will therefore appear much louder to the game player seated in the specific game chair playing the sound than to other game players seated around a wagering game table such as 301. In further embodiments, the game chair includes other features such as player tracking card acceptance and credit/cashout capability, while such features are incorporated into the game table 301 in other embodiments.

Sound is directed to a specific game player via other local speaker means in other embodiments, such as by headsets or earphones. One such embodiment uses a player's Bluetooth headset, as is shown in FIG. 5, to play sound that is audible only to a game player wearing the headset. Such enhanced privacy is particularly useful in certain applications, such as where some game players are actively playing the game, while other game players are listening to a tutorial on how to play the game or are being prompted to make a game play decision. The Bluetooth headset is provided in one example by the game player, who has his own Bluetooth headset for use with a cellular telephone or other electronic devices, while in other embodiments it is provided by the gaming establishment. In an alternate embodiment, a headphone jack is provided for a game player to plug in headphones, or headphones are hard-wired into the table and provided by the gaming establishment.

These examples show how various audio methods can be used to make a sound appear as though it follows a wagering game object, and how game player-specific speakers such as gaming chair, Bluetooth headset, or local speakers can be used to address individual game players. In other embodiments of the invention, a common set of speakers is used for audio presentation, such as a set of speakers built into a wagering game table or mounted over or near a wagering game table, and a different configuration of this set of speakers is used to address different players.

Such a configuration does not necessarily include a dedicated speaker that is local only to a particular intended game player, but uses an available set of speakers to selectively address one or more game players by varying the speaker configuration used for playback of certain sounds. This enables a speaker/audio system, such as a multichannel or surround-sound audio system, to be adapted to selectively address a game player, a group of game players, or a section of the game table.

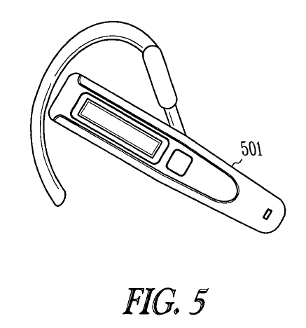

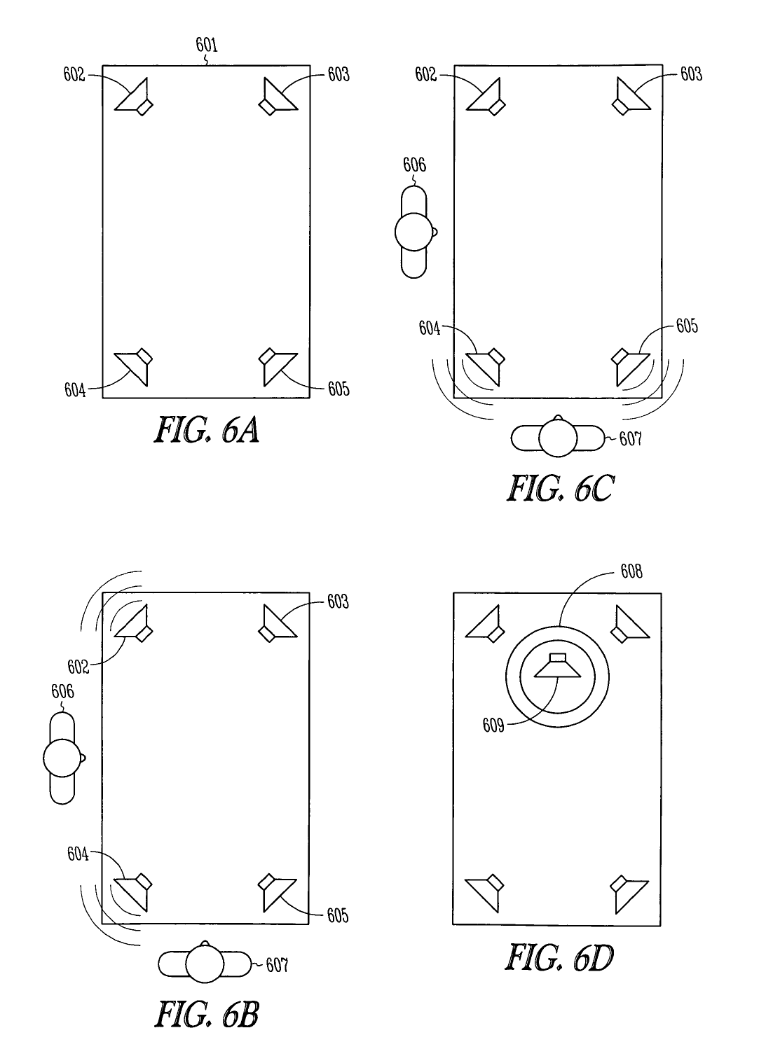

FIG. 6A shows an example wagering game table having multiple speakers operable to selectively direct sound to one of one or more game players, consistent with an example embodiment of the invention. Here, a table 601 has four speakers mounted in the vicinity of the table, such as in the table, under the table, over the table, or in chairs, stools, or other items located in the vicinity of the table. The speakers are distributed around the table to provide sound coverage to different regions of the table, such that speakers 602, 603, 604 and 605 are here each located near different corners of a rectangular table. Although the speakers are not located immediately at wagering game player positions or dedicated to specific game players, they are in this example distributed around the wagering game table to provide sound coverage to any desired region of the game table.

The speakers are coupled to an audio system that is operable to address at least some of the speakers independently of other speakers, such as by providing a separate audio signal to each of the speakers 602-605. In one such embodiment, a multichannel sound card for a computer is used to generate four distinct channels of sound. In another embodiment, an audio stream is generated that comprises multiple encoded audio channels, such as a Dolby Digital or DTS digital audio stream, that is decoded into discrete audio signals that are routed to the speakers 602-605. This enables the speakers to be addressed using a variety of different configurations, such as by reducing the volume to some speakers while increasing the volume to others, or providing select sounds only to some speakers and not to others.

FIGS. 6B and 6C shows a top view of the same wagering game table, but with game player 606 located to one side of the game table and game player 607 located at the end of the game table, consistent with an example embodiment of the invention. In this example, the wagering game player 606 is the active game player. This occurs when it is player 606's turn to bet, when player 606 has won, when credit bang-up is taking place for player 606, when player 606 needs instruction or prompting, or for other such reasons.

Here, sound is selectively presented to game player 606 by playing sound through the two speakers most near player 606's game play position at the table, such that the sound is louder or more directed toward player 606 than toward player 607. In this example, the speakers are each directed outward from their position at the table, while in other embodiments a variety of other speaker type, speaker configuration, and audio processing methods are used to provide or enhance selective directionality of the sound.

In FIG. 6C, the sound is selectively directed to player 607 rather than to player 606. An event or condition has made it desirable to direct sound to a particular game player rather than to all game players or to a game element, and so speakers 604 and 605 are used to present sound to the particular game player selected. This stands in contrast to FIG. 6B, in which speaker 602 was used and speaker 605 was not used, with the goal of selectively directing sound to a player located at a different position around the wagering game table.

The change in selective sound directionality between FIGS. 6B and 6C is in this example due to a change in the player currently most actively interacting with the wagering game table system, such as by player 606 completing his bet so that it is now player 607's turn to bet, by player 607 requesting instruction or being prompted to perform an action after player 606 has completed an action, or by player 607 initiating an action with the wagering game table system such as placing or changing a bet. In another example, the player to whom sound is selectively directed shifts from player 606 to player 607 after player 606 has completed a bonus game, credit bang-up, or other game play event, and moves on to player 607.

Detection of a player's position is in some cases as simple as determination of whether a player has deposited credits or made other player actions at a particular designated game player position at a wagering game table. In other examples, sensors such as infrared, ultrasonic, or conductive sensors can detect the presence or movement of a game player, and facilitates selectively directing sound to a particular game player.

FIG. 6D shows a modified version of the wagering game table of FIG. 6A, in which a wagering game element such as a roulette wheel 608 has its own speaker 609, further operable to be independently operated to provide sounds emanating from the wagering game element. In this example, the roulette wheel 608 is a projected or displayed roulette wheel image, and therefore does not itself make the sounds associated with a traditional mechanical roulette wheel. The speaker 609 is therefore selectively used to provide sound in conjunction with the operation of the roulette wheel, such as by making a sound when the wheel spins, when the roulette ball tracks around the wheel, and when the roulette ball bounces from wheel position to wheel position.

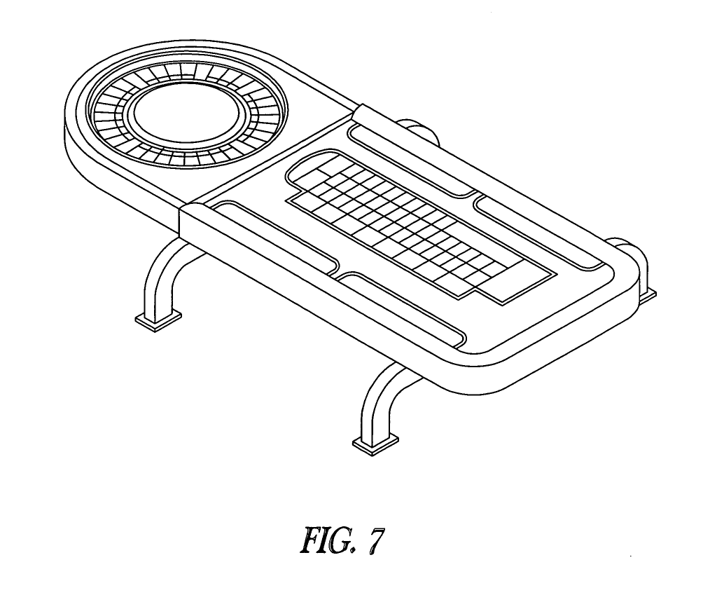

This example is shown in greater detail in FIG. 7, which is a rendered image of a Monopoly®-themed roulette-style wagering table game, consistent with an example embodiment of the invention. Here, the table resembles that of FIG. 6D, with a projected or displayed roulette wheel image on one end of the table, and four player locations identified at the opposite end of the table. Bets are placed in the middle of the player end of the table, and speakers are located at various positions around the table to facilitate selective direction of sound to players at the positions marked “Player 1” through “Player 4”. An additional speaker is positioned in the vicinity of the roulette wheel, such as under a projection screen onto which the wheel image is projected, or to the side of a display used to display the wheel.

Some embodiments of a wagering game table such as that of FIG. 7 include other apparatus designed to complement the speakers, such as a tactile feedback device or “shaker”, used to enhance the perception of low frequency sounds, impact sounds, and other multimedia presentation. Shaker devices, such as are often employed in car audio and home theater seating, can be used in some embodiments to enhance the perception of bass audio or of shaking, by vibrating the table at frequencies close to or below audio frequencies. Similarly, solenoids and other devices attached to the game table are used in some embodiments to provide a tactile sensation to a game player, such as upon a roulette ball being put into play or for other reasons. Both examples of tactile feedback presented here are likely to also produce some audible tone transmitted through the table, further coupling the tactile feedback and the audio presentation presented to the game player.

The examples presented here have shown how some embodiments of the invention present different sounds to different wagering game players at a wagering game table. A variety of technologies have been illustrated, including local speakers, directional speakers, amplitude, phase, and psychoacoustic processing, ultrasonic sound projection, and use of headsets or earplugs. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game table system, comprising:
a wagering game module, operable to present a wagering game upon which monetary value can be wagered;
a wagering game table; and
an audio system operable to present different sound to each of a plurality of game players seated at the wagering game table.

2. The computerized wagering game table system of claim 1, wherein the audio system is operable to present a sound to an intended game player while reducing its audibility to other game players by altering the phase of sound played through two or more speakers.

3. The computerized wagering game table system of claim 1, wherein the audio system is operable to present a sound to an intended game player while reducing its audibility to other game players by altering the amplitude of sound played through two or more speakers.

4. The computerized wagering game table system of claim 1, wherein the audio system is operable to present a sound to an intended game player while reducing its audibility to other game players by directing the sound via an acoustic reflector.

5. The computerized wagering game table system of claim 1, wherein the audio system is operable to present a sound to an intended game player while reducing its audibility to other game players by presenting the sound to the intended game player via a dipole speaker having a lobe aimed at the intended game player.

6. The computerized wagering game table system of claim 1, wherein the audio system is operable to present a sound to an intended game player while reducing its audibility to other game players by playing the sound through speakers comprising a part of a chair in which the intended game player sits.

7. The computerized wagering game table system of claim 1, wherein the audio system is operable to present a sound to an intended game player while reducing its audibility to other game players by playing the sound via an array of ultrasonic speakers operable to create an interference pattern that comprises the presented sound.

8. The computerized wagering game table system of claim 1, wherein the audio system is operable to present a sound to an intended game player while reducing its audibility to other game players by psychoacoustic processing of the played sound.

9. (canceled)

10. A method of operating a computerized wagering game table system, comprising:
presenting a wagering game upon which monetary value can be wagered via a wagering game table; and
presenting different sound to each of two or more game players seated at the wagering game table.

11. The method of operating a computerized wagering game table system of claim 10, wherein the sound is presented to each of two or more game players through two or more speakers, at least one speaker local to each game player.

12. The method of operating a computerized wagering game table system of claim 10, wherein presenting different sound to each of two or more game players comprises presenting a sound to an intended game player while reducing its audibility to other game players by altering the phase of sound played through two or more speakers.

13. The method of operating a computerized wagering game table system of claim 10, wherein presenting different sound to each of two or more game players comprises presenting a sound to an intended game player while reducing its audibility to other game players by altering the amplitude of sound played through two or more speakers.

14. The method of operating a computerized wagering game table system of claim 10, wherein presenting different sound to each of two or more game players comprises presenting a sound to an intended game player while reducing its audibility to other game players by directing the sound via an acoustic reflector.

15. The method of operating a computerized wagering game table system of claim 10, wherein presenting different sound to each of two or more game players comprises presenting a sound to an intended game player while reducing its audibility to other game players via a dipole speaker having a lobe aimed at the intended game player.

16. The method of operating a computerized wagering game table system of claim 10, wherein presenting different sound to each of two or more game players comprises playing the sound through speakers comprising a part of a chair in which the intended game player sits.

17. The method of operating a computerized wagering game table system of claim 10, wherein presenting different sound to each of two or more game players comprises presenting a sound to an intended game player while reducing its audibility to other game players playing the sound via an array of ultrasonic speakers operable to create a localized interference pattern that comprises the presented sound.

18. The method of operating a computerized wagering game table system of claim 10, wherein presenting different sound to each of two or more game players comprises presenting a sound to an intended game player while reducing its audibility to other game players by psychoacoustic processing of the played sound.

19. (canceled)

20. A computerized wagering game table system, comprising:
a wagering game module, operable to present a wagering game upon which monetary value can be wagered;
a wagering game table; and
an audio system operable to selectively direct sound to one of one or more wagering game players playing a wagering game at the wagering game table.

21. The computerized wagering game table system of claim 20, wherein the audio system comprises three or more speakers, each speaker independently controlled such that the speakers are operable to selectively direct sound to one of the one or more wagering game players.

22-23. (canceled)

24. The computerized wagering game table system of claim 20, wherein the audio system selectively directs sound by playing sound through three or more speakers using one of a plurality of speaker configurations, wherein different speaker configurations from the plurality of speaker configurations are configured to direct sound to a selected game player.

25. (canceled)

26. The computerized wagering game table system of claim 20, wherein the audio system is further operable to play player-specific sounds.

27. (canceled)

28. A method of operating a computerized wagering game table system, comprising:
presenting a wagering game upon which monetary value can be wagered on a wagering game table; and
selectively directing sound to one of one or more wagering game players playing a wagering game at the wagering game table.

29. The method of claim 28, wherein the audio system comprises three or more speakers, each speaker independently controlled such that the speakers are operable to selectively direct sound to one of the one or more wagering game players.

30-31. (canceled)

32. The method of claim 28, wherein the audio system selectively directs sound by playing sound through three or more speakers using one of a plurality of speaker configurations, wherein different speaker configurations from the plurality of speaker configurations are configured to direct sound to a selected game player.

33. (canceled)

34. The method of claim 28, wherein the audio system is further operable to play player-specific sounds.

35. (canceled)

36. The computerized wagering game table system of claim 20,
wherein the audio system is further operable to selectively direct sound to at least one wagering game element, such that the sound appears to a listener to approximately come from the wagering game element.

37. The computerized wagering game system of claim 36, wherein the sound directed to at least one wagering game element comprises at least one of the sound of dice rolling associated with displayed dice rolling, the sound of cards shuffling associated with displayed cards shuffling, the sound of chips splashing associated with displayed chips moving against one another, the sound of cards being dealt with a displayed image of cards being dealt; and the sound of a card sliding across the table associated with a displayed card moving across the table.

38. The method of operating a computerized wagering game table system of claim 28, and further comprising:
selectively directing sound to at least one wagering game element, such that the sound appears to a listener to approximately come from the wagering game element.

39. The method of operating a computerized wagering game table system of claim 38, wherein the sound directed to at least one wagering game element comprises at least one of the sound of dice rolling associated with displayed dice rolling, the sound of cards shuffling associated with displayed cards shuffling, the sound of chips splashing associated with displayed chips moving against one another, the sound of cards being dealt with a displayed image of cards being dealt; and the sound of a card sliding across the table associated with a displayed card moving across the table.
